(19) United States
(12) Patent Application Publication
(10) Pub. No.: US 2018/0300708 A1
(43) Pub. Date: Oct. 18, 2018

(54) Fin.do- Credit Marketplace Platform For Credit Installment Purchases At Point Of Sale

(71) Applicant: Zhana Dar, Kfar Saba (IL)

(72) Inventor: Zhana Dar, Kfar Saba (IL)

(21) Appl. No.: 15/766,918

(22) PCT Filed: Oct. 27, 2016
(86) PCT No.: PCT/IB2016/056455

§ 371 Date: Apr. 9, 2018

Related U.S. Application Data
(60) Provisional application No. 62/249,361, filed on Nov. 2, 2015.

(51) Int. Cl. G06Q 20/24; G06Q 20/22; G06Q 40/02

(52) U.S. Cl. CPC G06Q 20/24; G06Q 40/025; G06Q 20/223

(57) ABSTRACT

A method of providing an installment loan, comprising: sending a request for a loan of a specific sum by a purchaser holding proprietary payment means to an installment payment system, said purchaser at a POS; calculating by said installment payment system a credit score for said purchaser; determining by said installment payment system individual loan sum Y₀ and terms of payment for said purchaser using said calculated credit score; reserving said sum of Y₀ for said loan; purchasing goods from a merchant at said POS in a sum X≤Y₀ by said purchaser; paying said merchant the full purchase sum X by said installment payment system; and optionally performing a further purchase according to said individual terms of payment.

### TECHNOLOGY FIELD

The disclosure generally relates to the field of FinTech and more particularly to an installment means.

### BACKGROUND

The Fin-Tech industry is a changing financial eco-system, breaking conventional banking services into specific niches where FinTech startups each take on a specific niche (lending, money transfer, payments, exchange) —there will be further re-bundling of services, with startups plugging into one another while working together with each other and with existing financial eco-system thus providing a more transparent and consumer friendly products.

We believe there is an opportunity to go further than just replicating a full set of retail banking products, and focus on delivering an exceptional alternative financial product for the consumers, by building a unique social purchasing tool—Social Installment Purchasing (credit) Card/Wallet.

### The Prior Art Process

Besides the customer (card/wallet holder) and the Merchant/Service provider there are several additional players that play an important role in the process of payment card usage:

Issuer/Card Issuer—Financial institution, bank, credit union or company that issues or helps issue cards to cardholders. Issuers also work directly with end-users to implement and grow programs, issue cards and invoice posted credit, prepaid or debit card transactions. The issuer uses the services of the Card Network/Association and processors to facilitate card issuance, authorize transactions and provide data. Issuers are sometimes referred to as card “providers.”

Acquirer—a bank or financial institution that processes credit debit or prepaid card payments on behalf of a merchant. The term acquirer indicates that the bank accepts or acquires payment card payments from the card-issuing banks within an association.

Card Network (also known as Card association)—Visa, MasterCard or other networks that act as an intermediary between an acquirer and an issuer to process payment card transactions.

Credit Bureau—a company that collects information from various sources and provides consumer credit information on individual consumers for a variety of uses. It is an organization providing information on individuals' borrowing and bill-paying habits Credit information such as a person's previous loan performance, which is a powerful tool to predict his future behavior.

FIG. 1 is a schematic flow diagram showing prior art process of payment card payment eco-system: Card issuer 140 issues Card holder 100 a payment card (step 1). Card holder 100 initiates a purchase from a Merchant 110 (step 2). The Merchant 110 processes the transaction and sends authorization request to Acquirer 120 (step 3). The Acquirer sends authorization request to the Card network 130 (step 4). The card network sends authorization request to Issuer 140 (step 5). The Issuer 140 processes the request and sends authorization/decline to the Card network 130 (step 6). Card network 130 sends authorization/decline to Acquirer 120 (step 7). The Acquirer 120 sends approve/decline code to Merchant 110 (step 8).The Merchant 110 completes or declines transaction (step 9).

In today's world, consumers have only several options if they want to purchase goods and services using installments.

Some merchants provide store cards to their loyal clients, but it still limits the client to make purchases only from this specific merchant.

Some banks offer credit installment solutions. In order to be eligible for their services the client has to open an account in that bank (physical presence is required) with an active bank account (e.g. salary account) or put some collateral for such service. Approval of the credit or loan is based on customers' credit scoring, which is based on conventional data taken from credit bureaus or based on credit history within the same bank. This is why a large percentage of the population is not approved for credit line or loans. Even when approved for installment payment card by a bank, clients are limited to making installment purchases within selected merchants only.

A few Fintech startups offer installment solutions, but all of them limit their clients to purchase goods and services only from the selected merchants with whom they collaborate.

### BRIEF DESCRIPTION OF THE DRAWINGS

For better understanding of the invention and to show how the same may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 is a schematic flow diagram showing prior art process of payment card payment eco-system;

FIG. 2 is a schematic flow diagram showing the process of registration and issuing a new card by Fin.do;

FIG. 3 is a schematic flow diagram showing Fin.do's payment card system;

FIG. 4 is a schematic flow diagram illustrating how the money is collected from the card holder; and

FIGS. 5 and 6 are flow charts showing three possible processes of the system according to the present invention.

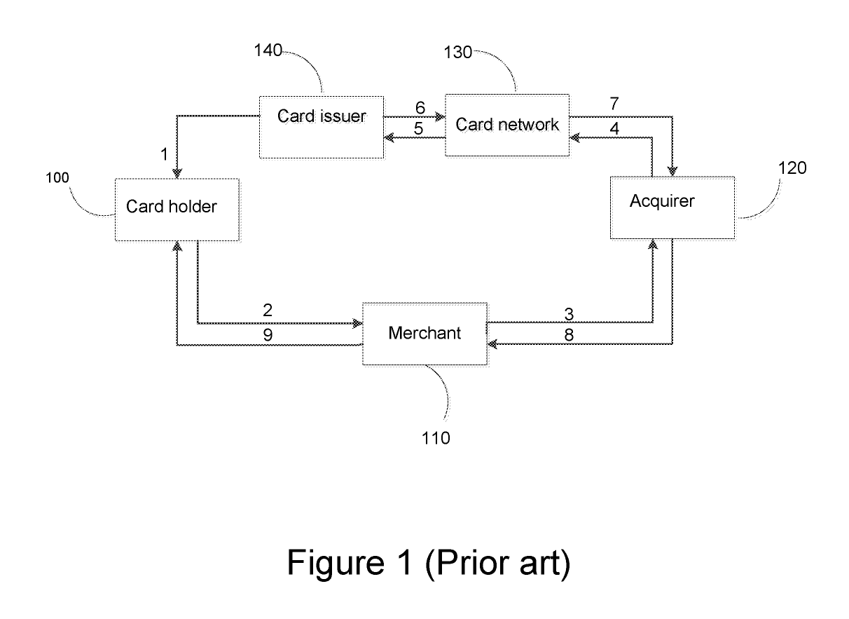

### SUMMARY

Fin.do—For Consumers:

1. First Credit Marketplace for Installment Purchasing Payment Card/Wallet—Alternative financial solution where people empower people for more flexible financial solutions, allowing them to purchase goods and services using installments everywhere where e.g. Mastercard®/Visa®/e-Wallets are accepted. (Online, Offline).

2. Daily Revolving/Multiple loan per customer request.

3. Advanced credit scoring algorithm, based amongst other, on social & web profiling.

4. Managing purchases by hassle-free monthly installment payments.

5. Consumer friendly platform to manage personal finances easier and more conveniently.

Fin.do—For Investors/Lenders:

The first social funding model allowing anyone to invest in credit worthy consumer.

Fin.do—Benefits for Merchants:

1. Enlarges merchants' sales and conversion rates without any risk involved.

2. Customized marketing tool, addressing the right consumer.

3. Lowering marketing costs.

### DETAIL DESCRIPTION OF EMBODIMENTS

The present invention provides a disruptively innovative and easy to use financial system that innovates and improves consumer purchase experience. “Fin.do” is a technology to re-imagine and re-build core components of financial infrastructure from the ground up. Our focus is to improve the purchasing capabilities of everyday consumers with less expensive, more transparent financial products. By splitting purchases into multiple payments (installments), we give our clients the flexibility and comfort they need in today's time-pressurized world.

The objective is attained by combining conventional financing banking practices with Fin-Tech innovation solutions. Thus Fin.do is one of a kind alternative financial provider that uses the existing payment infrastructure to improve consumer purchasing experience.

The project's core concept builds on the existing Card Network infrastructure; “Fin.do” enables its customers to shop for goods and services and pay later with monthly installments. “Fin.do” can be used for e-commerce or brick and mortar merchants at the point of sale, everywhere and anywhere. The service can be used online, offline, on mobile or web browsers, using all payment technologies currently available (in any currencies, as well as virtual currencies such as bitcoin or any other virtual currency based on blockchain solution or any other Alternative chains or\and any other technologies which are based on a decentralized system\public distributed ledger that might appear in the future). Upon the completion of our client's purchase, the merchant receives the full amount directly from “Fin.do”.

To be able to provide our clients with a personalized loan, Fin.do evaluates their credit scoring using both conventional and non-conventional methods.

The project is divided into three main phases:

### 1. Services for Approved Clients Only.

The loyal clients are able to enjoy lower costs and interest rates. By learning clients' purchasing behavior Fin.do is able to provide a more customized solution for each client, providing information about special deals and discounts and empowering client with better decision making capability before making the actual purchase.

2. Collaboration with Merchants that Offer a 0% Installment Plan.

By learning the clients' purchasing behavior, Fin.do is able to connect merchants with the right consumers, improving merchants' conversion rate, lowering marketing costs and endorsing merchants' services.

### 3. Crowd Funding Model—Pool to Pool Investment.

Everyone, from private individuals, companies and governmental organizations can invest through Fin.do platform.

Creating alternative financial tools for peer-to-peer investors/lenders, who wish to diversify their investments across a variety of asset classes and subclasses, giving their portfolio consistency and peace-of-mind.

The combination of existing Card Network Infrastructure with FinTech technologies allows Fin.do to provide a better financial solution for the benefit of both consumers, merchants and investors/lenders.

The present invention provides a system and a method for providing electronic payment means, which can be used anywhere (offline or online) where electronic payment means are accepted (e.g., credit card, debit card, prepaid card, mobile phone, digital wallet).

For a client holding a bank account in any financial institution, the ultimate means of payment would be a Fin.do Payment card (virtual or physical) which can offer the client the possibility of installments and optionally multiple/revolving loans, without the need of collateral.

The appeal of installment buying is that it allows prospective purchasers to enjoy the advantages of owning relatively expensive goods/services while paying for them gradually out of their future income, instead of having to save the necessary purchase price out of their income first. Installment loan can thus greatly expand the purchasing power of ordinary consumers.

Potential users may be, for example, households, individuals lacking credit score records or ones who need to purchase goods and services and don't have the possibility to pay in one payment.

All references to electronic payment means may refer to any of the following means: credit card, debit card, prepaid card, digital wallet, mobile phone etc. Also, references to card holder also refer to client/consumer.

In the present invention, Fin.do acts as credit marketplace platform for the benefit of consumers, lenders and merchants. Fin.do may acquire banking licenses as well in order to provide the full cycle of the installment purchases (in this case Fin.do becomes an issuer itself) for consumers and will allow deposit accounts for both consumers and investors.

Fin.do's system has two modules:

1. Registration and credit module—handles registration of new Fin.do card holders and calculates card holder's credit score, or may use third party providers in order to do so, optionally by mixing several credit score assessment sources such as credit bureaus and excess information taken from address, phone, email, bills' payment history and social networks. In the registration stage, the potential Fin.do card holder signs a general agreement with Fin.do. When applying for a loan at a Point of Sale (POS) (before making a purchase), the Fin.do card holder receives individual terms to use Fin.do's services such as a loan sum Y₀, installment programs, etc., according to the recalculated credit score, including for example average monthly/annually loan.

2. Card issuer module—issuing Fin.do cards with specific BIN (Bank Identification Number) for Fin.do.

Fin.do charges processing fee, which for example, may be determined as a certain percentage of each loan (the card holder may apply for multiple loans in parallel).

According to embodiments of the invention, the loan may be valid for at least one business day and\or 24 hours or any other period that is agreed with the client.

When a client receives a Fin.do payment card (virtual or physical) or e-Wallet from Fin.do, it is an empty card/e-wallet, without any loan available. The card/e-Wallet will be loaded only when the client sends a request for credit installment purchase at a POS and will be loaded with a loan in the sum Y₀. Optionally Fin.do will be able to upload an existing Fin.do payment card that the consumer already possesses with the sum Y₀, depending on the client's preferences. Fin.do's bank account reserves a sum of Y₀ or sends request to any partnering bank/financial institution/investor/lender to reserve the sum Y₀. The sum Y0 will be reserved at Fin.do's bank in order to upload consumer's Fin.do Payment Card at Point of Sale for e.g. a 24-hour period. Consumer can make purchases with Fin.do's payment Card anywhere where the merchant is connected to a Card Network, e.g. Visa®, MasterCard® or any other means of electronic payments. Thus he has numerous possibilities of making purchases.

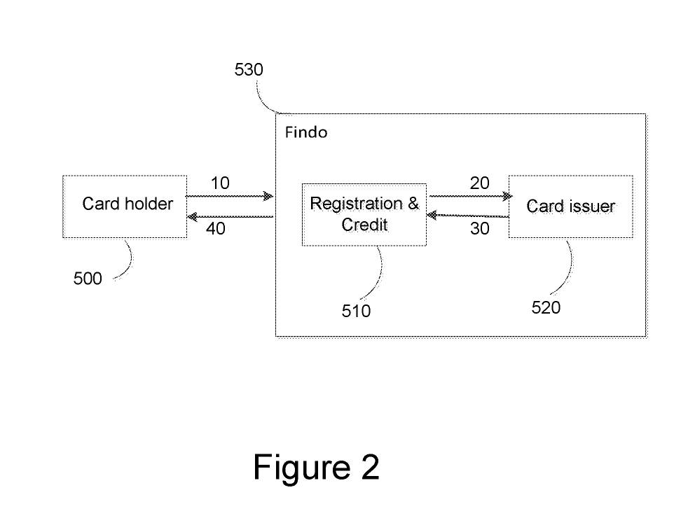

FIG. 2 is a schematic flow diagram clarifying the process of registration and issuing a new Fin.do card: The potential Fin.do Card holder 500 applies for Fin.do's 530 card/services through a registration process made by Registration and Credit module 510, filling out the application form (step 10). Registration and Credit module 510 checks the potential Card holder 500 credit score and disapproves (step 40) or approves to proceed with the issuing process for the potential Fin.do Card holder 500 for its services (step 20). Card issuer module 520 issues a Fin.do card (physical or virtual) with specific BIN (Bank Identification Number) for Fin.do 530 and sends it to Registration and Credit module 510 (step 30).

Registration and Credit module 510 sends the Fin.do card to the Card holder 500 address or a virtual Fin.do card is created for the Card holder 500 (step 40).

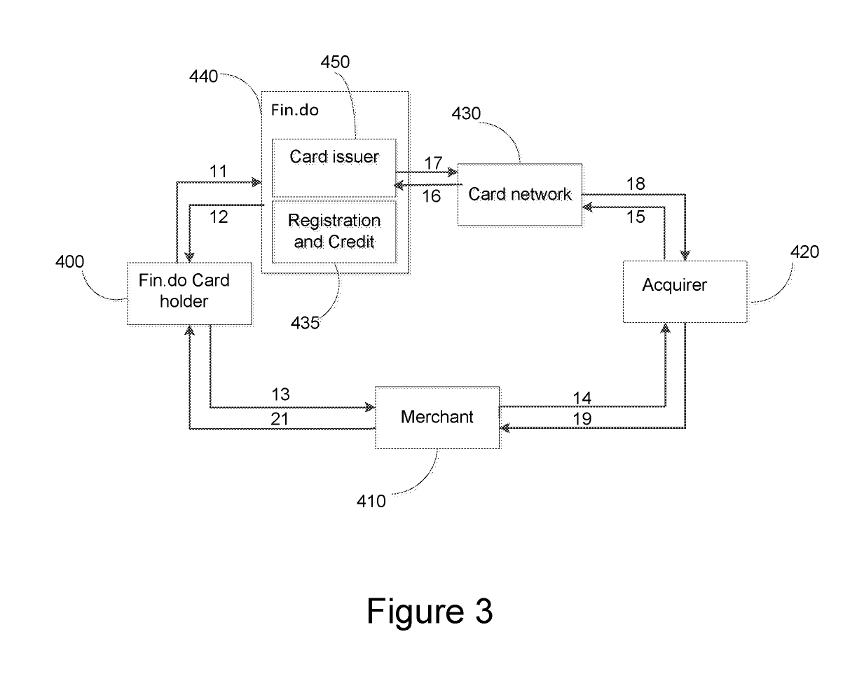

FIG. 3 is a schematic flow diagram showing Fin.do's payment card system: Fin.do Card holder 400 about to perform an installment purchase at a POS sends a loan request to Fin.do 440, by mobile application, web account or other electronic means, to load his Fin.do payment card with a certain sum of money in order to make the purchase (step 11). In case of approval, Fin.do 440 provides the Fin.do Card holder 400 with loan sum Y₀ the sum requested by the card holder), at least one installment plan, total cost including interest and fees, which is stored in the Card Issuer module 450 account for this specific Fin.do Card holder 400. If the request is disapproved, the Fin.do Card holder 400 receives a notice (step 12).

The Fin.do card holder 400 initiates a purchase from the Merchant 410 (step 13). The Merchant 410 processes the transaction and sends authorization request to Acquirer 420 (step 14). The Acquirer 420 sends authorization request to the Card network 430 (step 15). The Card network 430 sends authorization request to Fin.do's Card issuer module 450 (step 16). Card Issuer module 450 processes the request and sends authorization/decline to the Card network 430 (step 17). Card network 430 sends authorization/decline to Acquirer 420 (step 18). The Acquirer 420 sends approve/decline code to Merchant 410 (step 19).The Merchant 410 completes or declines the transaction (step 21).

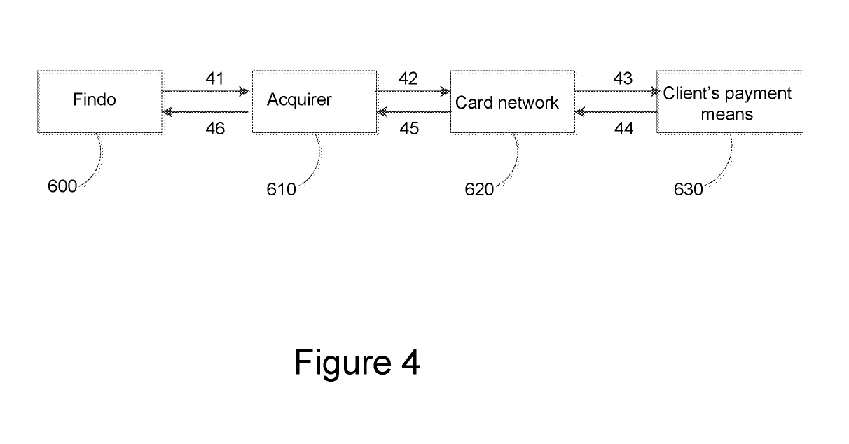

FIG. 4 is a schematic flow diagram illustrating how the money is collected from the card holder: Fin.do 600 in the role of a merchant, applies through acquirer 610 to receive the due installment payment from the client/Fin.do's card holder (step 41). The acquirer through the Card network 620 (step 42) applies to the Client's payment means (bank) 630 where the client holds a bank account or debit card (step 43). The Client's payment means 630 approves or rejects the sum of due payment by the client through the Card network 620 (step 44), which transfers the approval/disapproval to the Acquirer 610 (step 45), that finally transfers the payment to Fin.do 600 in case of approval or delivers a rejection notice (step 46).

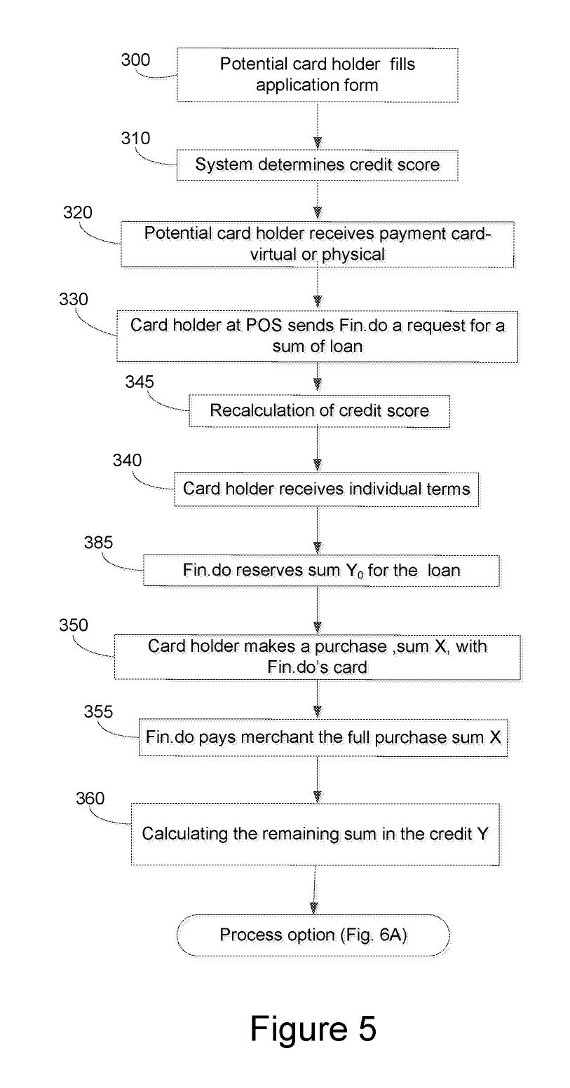

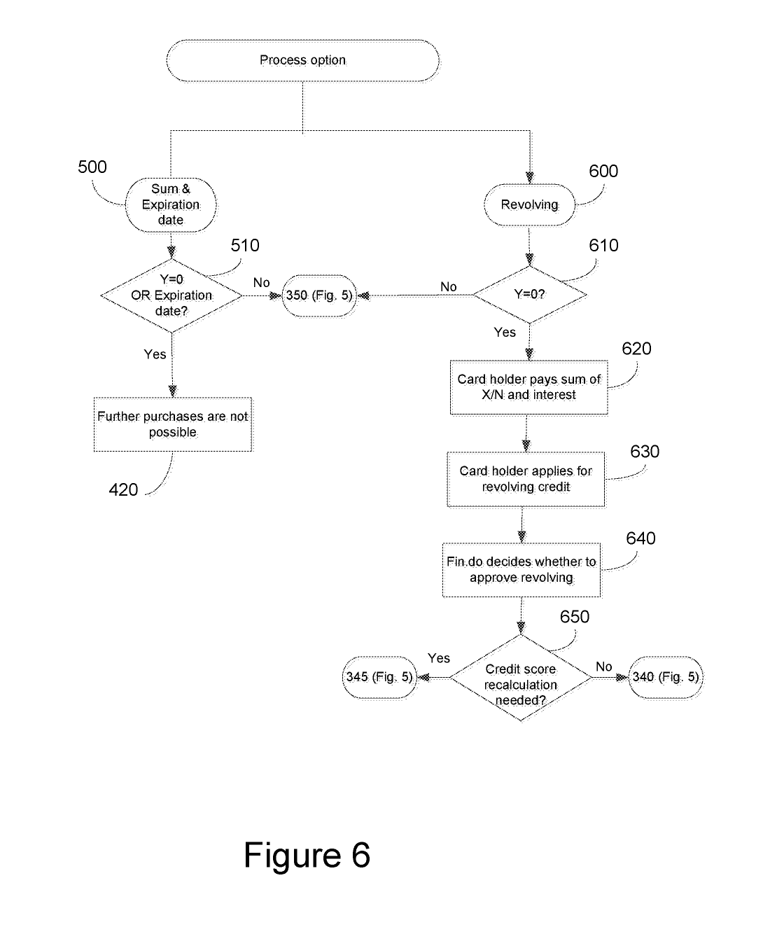

FIGS. 5-6 are flow charts showing two possible processes of the system, through which the Fin.do card holder may apply for a loan. The Fin.do card holder may use all the processes described in FIGS. 5-6 in any possible combination (e.g. repeating a certain process several times or combining the processes) at the same time, thus applying for parallel/multiple loans.

FIG. 5: Shows the basic process common to the two processes. The potential Fin.do card holder registers to the service by filling an application form 300, providing all the necessary information, on Fin.do's website. Fin.do's system determines applicant's credit score 310 (optionally by mixing several credit score assessment sources such as credit bureaus and social networks). The applicant receives a payment card (virtual/physical) 320.

When the Fin.do card holder is about to perform a purchase at a POS, he sends Fin.do a request for a sum of loan 330, Fin.do's system recalculates the client's credit score 345 and the Fin.do card holder receives from Fin.do individual terms to use Fin.do's services: e.g., loan expiration date, at least one plan of N installment payments, total cost including interest and fees and sum of approved loan Y₀ 340. Once the sum of loan Y₀ has been determined, Fin.do reserves that sum in Fin.do's account 385.

The Fin.do card holder makes a purchase in the sum of X≤Y₀ with Fin.do's payment card 350. Fin.do pays the merchant the full purchase sum X 355 from Fin.do's bank account. The remaining sum in the loan is calculated Y=Y₀−X 360.

FIG. 6 divides the process into two options:

Sum & Expiration Date 500—There are two conditions for enabling further purchases using the current loan: (1) Y (remaining loan) is bigger than 0; (2) The loan has not reached its expiration date. If one of the conditions Y=0 or loan expired is true 510, further purchases are not possible 420. Otherwise, the Fin.do card holder can make another purchase (350, FIG. 5).

Revolving loan 600—A revolving loan is available to the Fin.do card holder. If Y=0 610, the Fin.do card holder may try to use the revolving loan option only after paying the first installment payment in the sum of e.g. X/N and interest 620. After paying the first installment payment, the Fin.do card holder applies for revolving loan 630 and Fin.do determines whether to approve revolving loan 640. If a decision was made to approve the revolving loan, Fin.do checks whether credit score recalculation is needed for this Fin.do card holder 650. If recalculation is required, the system goes back to step 345 (FIG. 5).

Otherwise, the system goes back to step 350 (FIG. 5).

1. A Point of Sale (POS) installments payment system comprising:
a system server comprising:
a registration and credit module configured to enable registration to the system; and
a card issuer module configured to issue proprietary payment means;
a purchaser holding said proprietary payment means communicating with said system server, said purchaser configured to request at least one loan sum for a credit installment purchase from said card issuer module at a POS, wherein said card issuer module, upon approval of said request, is configured to provide said purchaser with an installment loan sum and an installment plan;
a merchant entity communicating with said purchaser, said merchant entity configured to receive a purchase sum from said proprietary payment means, said purchase sum not larger than said loan sum;
an acquirer entity communicating with said merchant entity, said acquirer entity configured to approve or deny said purchase sum; and
a card network communicating with said acquirer entity and with said system server, said card network configured to receive approval or denial of said purchase sum from said system server and communicate it to said acquirer,
wherein said card issuer module is further configured to collect said installment payments due.

2. The system of claim 1, wherein said proprietary payment means comprises electronic payment means.

3. The system of claim 2, wherein said electronic payment means comprise one of a debit card, a credit card, a prepaid card, a digital wallet and a mobile wallet/phone.

4. A method of providing a peer-to-peer installment loan, comprising:
sending a request for a loan of a specific sum Y₀ for an installment purchase by a purchaser holding proprietary payment means to an installment payment system, said purchaser at a POS (Point of Sale), said POS not in communication with said installment payment system;
calculating by said installment payment system a credit score for said purchaser;
determining by said installment payment system individual loan sum Y₀ and terms of installment payments for said purchaser using said calculated credit score;
reserving said sum of Y₀ for said loan;
purchasing goods from a merchant at said POS in a sum X≤Y₀ by said purchaser;
paying said merchant the full purchase sum X by said installment payment system;
optionally performing a further purchase according to said individual terms of payment; and
collecting said installment payments due by said installment payment system, wherein said reserving said sum comprises reserving by at least one of investors, lenders and a pool of investors and/or lenders.

5. The method of claim 4, further comprising:
registering by said purchaser to said installment payment system; and
issuing by said installment payment system a payment card to said purchaser.

6. The method of claim 5, wherein said issuing a payment card comprises:
calculating by said installment payment system a credit score for said purchaser; and
using said calculated credit score for issuing said purchaser a payment card by said installment payment system.

7. The method of claim 4, wherein said individual terms of payment comprise:
loan expiration date;
number of installment payments N; and
cost of transaction.

8. The method of claim 7, wherein said optionally performing a further purchase comprises performing a further purchase if said loan has not expired.

9. The method of claim 4, wherein said optionally performing a further purchase comprises:
calculating by said installment payment system the remaining sum in said loan Y=Y₀−X;
permitting further purchases if said remaining sum in the loan Y>0; and
prohibiting further purchase if said remaining sum in the loan Y=0.

10. The method of claim 4, wherein said optionally performing a further purchase comprises:
calculating by said installment payment system the remaining sum in said loan Y=Y₀−X;
permitting further purchases if said remaining sum in the loan Y>0;
paying by said purchaser at least a first installment payment if said remaining sum in the loan Y=0;
applying by said purchaser for a revolving loan;
deciding by said installment payment system whether to approve said revolving loan;
prohibiting said further purchases if said approval of revolving loan is declined; and
reserving by said installment payment system a sum for said new loan.

11. The method of claim 10, wherein approving said revolving loan by said installment payment system comprises:
deciding if recalculation of said credit score is needed;
recalculating said credit score if said recalculation is needed; and
determining said individual terms.

12. The method of claim 4, wherein said reserving said sum comprises reserving by at least one of: said installment payment system, a partnering financial institution; an investor and a lender.
